(19) United States
(12) Patent Application Publication
(10) Pub. No.: US 2021/0347361 A1
(43) Pub. Date: Nov. 11, 2021

(54) VEHICLE POWER CONTROL SYSTEM USING BIG DATA

(71) Applicants: Hyundai Motor Company, Seoul (KR); Kia Motors Corporation, Seoul (KR)

(72) Inventor: Hyun Soo PARK, Seoul (KR)

(73) Assignees: Hyundai Motor Company, Seoul (KR); Kia Motors Corporation, Seoul (KR)

(21) Appl. No.: 16/995,516

(22) Filed: Aug. 17, 2020

(30) Foreign Application Priority Data
May 8, 2020 (KR) 10-2020-0054825

(51) Int. Cl. B60W 30/188; B60W 10/26; B60W 10/08; B60W 40/107

(52) U.S. Cl. CPC B60W 30/188; B60W 10/26; B60W 2510/244; B60W 40/107; B60W 2556/05; B60W 10/08

(57) ABSTRACT

A vehicle power control system using big data, may include a big-data server configured to receive driving-related data of a vehicle, generated by the vehicle, to generate a factor related to an acceleration pattern of the vehicle by processing the received driving-related data, and to store the generated factor, and a controller installed in the vehicle and configured to, when the vehicle is requested to be accelerated or propelled, change output power of a battery with reference to pre-stored available power of the battery and the factor stored in the big-data server.

### CROSS-REFERENCE TO THE RELATED APPLICATION

The present application claims priority to Korean Patent Application No. 10-2020-0054825, filed on May 8, 2020 in the Korean Intellectual Property Office, the entire contents of which is incorporated herein for all purposes by this reference.

### BACKGROUND OF THE PRESENT INVENTION

### Field of the Invention

The present invention relates to a vehicle power control system using big data, and more particularly to a vehicle power control system using big data for establishing an acceleration pattern of a vehicle using big data obtained through a big-data server and controlling power of the vehicle using the established acceleration pattern.

### Description of Related Art

In general, an available power value during charging and discharging of a high-voltage battery for storing driving power of an eco-friendly vehicle is a value corresponding to a power value which is continuously chargeable and dischargeable for a reference time, and the available power value may be predetermined, may be stored in a battery management system (BMS) in a vehicle in a form of data map, and may be applied to power control of the vehicle.

Accordingly, when a driver wants higher vehicle acceleration or propulsion, a vehicle is configured for outputting power only in a range of the pre-stored available power value, and thus there is a problem in that it is not possible to actually embody the vehicle acceleration or propulsion required by the driver.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a vehicle power control system using big data for establishing an acceleration pattern of a vehicle using big data obtained through a big-data server and controlling power of the vehicle to achieve acceleration or propulsion desired by a driver using the established acceleration pattern when the vehicle is propelled.

In accordance with an aspect of the present invention, the above and other objects may be accomplished by the provision of a vehicle power control system using big data including a big-data server configured to receive driving-related data of a vehicle, generated by the vehicle, to generate a factor related to an acceleration pattern of the vehicle by processing the received data, and to store the generated factor, and a controller installed in the vehicle and configured to, when the vehicle is requested to be accelerated or propelled, change output power of a battery with reference to pre-stored available power of the battery and the factor stored in the big-data server.

The big-data server may group acceleration patterns having similarity based on the factor, and may determine high-output tolerance corresponding to a corresponding acceleration pattern for each grouped group.

The big-data server may have a plurality of hierarchical structures, and may include a low-ranking layer cloud server which is lower than a predetermined layer cloud server, the low-ranking layer cloud server configured to directly receive the data related to the driving of the vehicle from the vehicle and to classify data used to determine the factor, related to the acceleration pattern, and a high-ranking layer cloud server which is higher than the predetermined layer, the high-ranking layer cloud server configured to generate the factor by receiving and processing the data classified by the low-ranking layer cloud server, and to group acceleration patterns having similarity based on the generated factor.

The pre-stored available power of the battery may be stored in the controller in a form of data map based on a state of charge (SOC) value of the battery and a temperature around the battery.

The controller finally may determine output power of the battery by applying the high-output tolerance to the pre-stored available power of the battery when the vehicle is in an acceleration or propulsion condition.

The high-output tolerance may be a weight varying over time, to which characteristics of the acceleration patterns belonging to the respective groups are applied.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating the configuration of the vehicle power control system using big data according to various exemplary embodiments of the present invention;

FIG. 2 is a flowchart showing an operation of a vehicle power control system using big data according to various exemplary embodiments of the present invention; and

FIG. 3, FIG. 4, and FIG. 5 are graphs for comparison between conventional battery output power when a vehicle is propelled and battery output power when the vehicle is propelled using a vehicle power control system using big data according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a vehicle power control system using big data according to various embodiments of the present invention will be described with reference to the accompanying drawings.

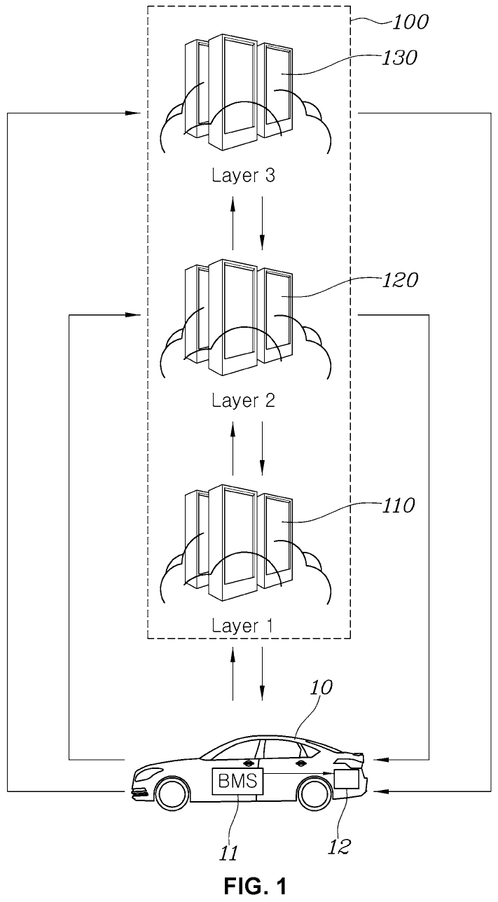

FIG. 1 is a diagram illustrating the configuration of the vehicle power control system using big data according to various exemplary embodiments of the present invention.

Referring to FIG. 1, the vehicle power control system using big data according to various exemplary embodiments of the present invention may include a big-data server 100 configured to receive driving-related data generated by a vehicle 10, to generate a factor related to an acceleration pattern of the vehicle 10 by processing the received data, and to store the generated factor, and a controller 11 disposed in the vehicle 10 and configured to change output power of a battery 12 with reference to pre-stored available power of the battery and the factor stored in the big-data server 100 when acceleration or propulsion of the vehicle 10 is required.

The big-data server 100 may receive various data generated while a vehicle travels from the vehicle 10, may generate data by processing and analyzing the received data, and may store the generated data. The big-data server 100 may generate a specific pattern related to acceleration of the vehicle based on data received from the vehicle or secondary generated data.

As shown in FIG. 1, the big-data server 100 may be embodied using a distributed cloud method of a hierarchical structure having cloud servers 110, 120, and 130 for respective layers.

For example, the first-layer cloud server 110 belonging to the lowermost layer of a plurality of hierarchical structures may communicate with the vehicle 10, may log data generated by the vehicle 10 in real time, and may provide the logged data to the vehicle 10 if necessary, or may provide the data to the cloud servers 120 and 130 belonging to a high-ranking layer of the lowermost layer 110.

The cloud servers 120 and 130 belonging to a high-ranking layer may process and store data provided by a cloud server of a low-ranking layer and may communicate with the vehicle 10 to transmit the processed data to the vehicle 10. FIG. 1 is a diagram for explaining an example of an exemplary embodiment in which a total of three layers is embodied, and the number of layers may be appropriately adjusted as necessary.

The exemplary embodiment of the present invention shown in FIG. 1 may include the first-layer cloud server 110 configured to log data of the vehicle in real time while communicating with the vehicle 10, the second-layer cloud server 120 configured to generate a factor for generating an acceleration pattern of the vehicle 10 by processing the data logged by the first-layer cloud server 110, and the third-layer cloud server 130 configured to generate the acceleration pattern of the vehicle using the factors generated by the second-layer cloud server 120 and to group similar acceleration patterns.

The first-layer cloud server 110 may log raw data generated by a vehicle in real time via communication with the vehicle. The first-layer cloud server 110 may log and store vehicle data at a low sampling rate as possible without data loss. The first-layer cloud server 110 may set a limit in the number of data to be logged and stored per vehicle which is a communication target. Needless to say, if resources are permitted, all data logged from a vehicle may be stored, the first-layer cloud server 110 communicates with the vehicle mainly in real time, and thus the number of data to be stored per vehicle may be limited to effectively use resources.

The raw data logged by the first-layer cloud server 110 may be data which is generated and transmitted by various controllers of a vehicle. In battery power control according to various embodiments of the present invention, real-time data provided to the first-layer cloud server 110 from the vehicle 10 may be data related to power of the battery 12 mounted in a vehicle, and may be, for example, a battery temperature of the vehicle 10, a battery voltage, the state of charge (SOC) value of the battery, a charging and discharging state of the battery, the current power of the battery, a vehicle speed, revolutions per minute (rpm) of a motor, the position of the vehicle 10, or a gradient.

The first-layer cloud server 110 may directly receive various driving-related data from the vehicle 10 and may also classify data to be used to determine a factor related to an acceleration pattern of the vehicle.

The vehicle 10 may make a request to the first-layer cloud server 110 for stored data and may also receive the data as necessary.

The second-layer cloud server 120 may determine an item such as an average, the maximum and minimum values, RMS, or a standard deviation by primarily processing the raw data logged by the first-layer cloud server 110 and may store the determined item. The processed data may be stored and managed in a form of a preset data set. The data stored in the second-layer cloud server 120 may be stored in the predetermined form of processed data but not raw data and may be stored along with the weather, a driving time, or the like of the corresponding data.

The first-layer cloud server 110 may immediately store the logged raw data, but the second-layer cloud server 120 may process the logged data and may not necessarily process and store raw data in real time, and a delay time to some degree may be allowed until data is processed and stored after data is received.

In battery power control according to various embodiments of the present invention, data processed and determined by the second-layer cloud server 120 may correspond to a factor to be used to generate an acceleration pattern of the vehicle 10. The factor to be used to generate the acceleration pattern may include the maximum power of the battery 12, the time at which the maximum power is maintained, average power, temperature, the state of charge (SoC), a position or a gradient in which the vehicle 10 travels, or a vehicle speed.

As necessary, the vehicle 10 may make a request to the second-layer cloud server 120 for processed data and may receive the processed data.

The third-layer cloud server 130 may secondarily re-process the data processed by the second-layer cloud server 120. The third-layer cloud server 130 may perform data processing that requires higher computation capability than computation used in data processing of the second-layer cloud server 120.

According to various exemplary embodiments of the present invention, the third-layer cloud server 130 may generate an acceleration pattern of the vehicle 10 that provides data, based on the maximum power generated by the second-layer cloud server 120, the time at which the maximum power is maintained, average power, temperature, a state of charge (SoC), a position or a gradient in which the vehicle 10 travels, or a vehicle speed and may group vehicles having similar acceleration patterns into one group.

The controller 11 disposed in the vehicle 10 may check whether the vehicle is accelerated and/or propulsion condition is propelled, may derive a pre-stored available power value of the battery 12 in an acceleration and/or propulsion condition, and may adjust power of the battery 12 based on the derived available power value and an acceleration pattern of the group to which the vehicle belongs, stored in the big-data server 100.

Here, the acceleration and/or propulsion condition may be determined by receiving a detecting value of a sensor for detecting a degree by which a driver depresses an accelerator pedal by another controller of the vehicle, and the controller 11 may receive information on the acceleration and/or propulsion condition from the other controller of the vehicle.

The controller 11 may monitor and manage charged and discharged power of the battery 12, and thus may be a battery management system (BMS) for performing control related to the battery 12.

The battery 12 may be a high-voltage battery for supplying power for driving a motor configured for providing power to a driving wheel of the vehicle.

A detailed operation of the vehicle power control system using big data according to various embodiments of the present invention as configured above will be described.

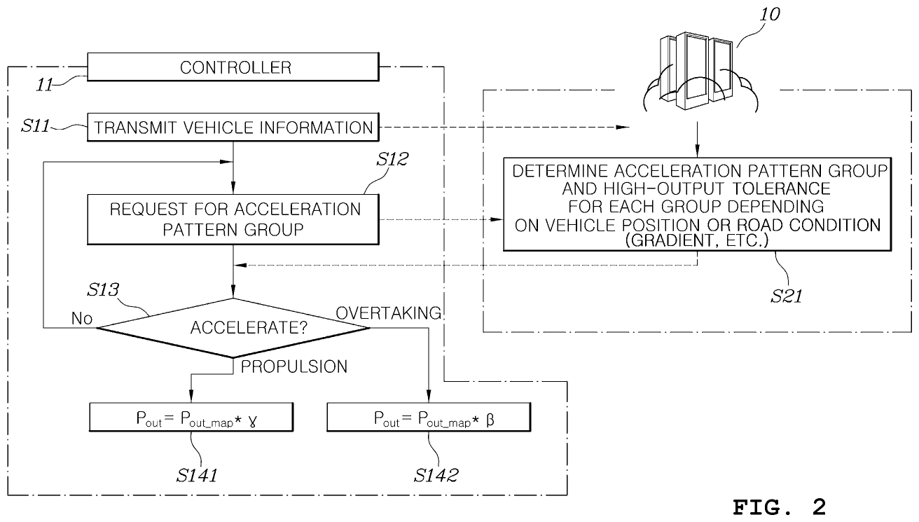

FIG. 2 is a flowchart showing an operation of a vehicle power control system using big data according to various exemplary embodiments of the present invention.

The operation shown in FIG. 2 may be performed by the controller 11 and the big-data server 100 of the vehicle 10.

Referring to FIG. 2, when the vehicle 10 is powered on, the vehicle 10 may provide data related to driving of the vehicle to the big-data server 100 every preset time interval (S11). The big-data server 100 may establish the acceleration pattern of the vehicle by processing the data related to driving of the vehicle received from various vehicles and may group similar patterns based on a factor used to establish the acceleration pattern of the vehicle (S21). In operation S21, the acceleration pattern of the vehicle 10 that provides the data to the big-data server 100 may be grouped with other acceleration patterns having similar characteristics.

The acceleration pattern considered in the grouping may include a propulsion acceleration pattern and an overtaking acceleration pattern. The propulsion acceleration pattern may refer to a pattern in which a vehicle is accelerated from a stationary state, and the overtaking acceleration pattern refers to a pattern in which, while traveling at a predetermined speed or greater, the vehicle is accelerated at a greater speed than the predetermined speed.

The big-data server 100 may determine high-output tolerances γ and β corresponding to acceleration patterns belonging to respective groups for each group which is grouped in operation S21. The high-output tolerances γ and β may be a function dependent upon time and may correspond to a weight which is changed over time, to which the characteristics of the acceleration patterns belonging to respective groups are applied. The high-output propulsion tolerance γ may be applied to the propulsion acceleration pattern, and the high-output overtaking tolerance β may be applied to the overtaking acceleration pattern.

Every preset time interval or in a specific vehicle traveling state (e.g., immediately after a vehicle is turned on), the controller 11 may make a request to the big-data server 100 for information on the group of the acceleration pattern and may receive the information (S12).

Accordingly, when the vehicle is requested to be accelerated, the controller 11 may determine whether the corresponding acceleration is propulsion acceleration or overtaking acceleration (S13), when the corresponding acceleration is propulsion acceleration, the controller 11 may determine final battery output power Pₒᵤₜ by applying the high-output propulsion tolerance γ corresponding to the group of the propulsion acceleration pattern to an available power value P_{out_ref} of the battery 12, which is set in a pre-stored data map (S141), and when the corresponding acceleration is overtaking acceleration, the controller 11 may determine the final battery output power Pₒᵤₜ by applying the high-output overtaking tolerance β corresponding to the group of the overtaking acceleration pattern to the available power value P_{out_ref} of the battery 12, which is set in the pre-stored data map (S142)

The map data stored by the controller 11 may record the available power value P_{out_ref} which is preset for each reference of the state of charge (SOC) value of the battery 12 and the temperature around the battery 12.

In operation S141, the controller 11 may transmit the output power Pₒᵤₜ of the battery 12, to which the high-output propulsion tolerance γ provided by the big-data server 100 is applied, to various controllers of the vehicle and may apply the same to various controls of the vehicle, in particular, motor control for propulsion and acceleration within newly set output power Pₒᵤₜ.

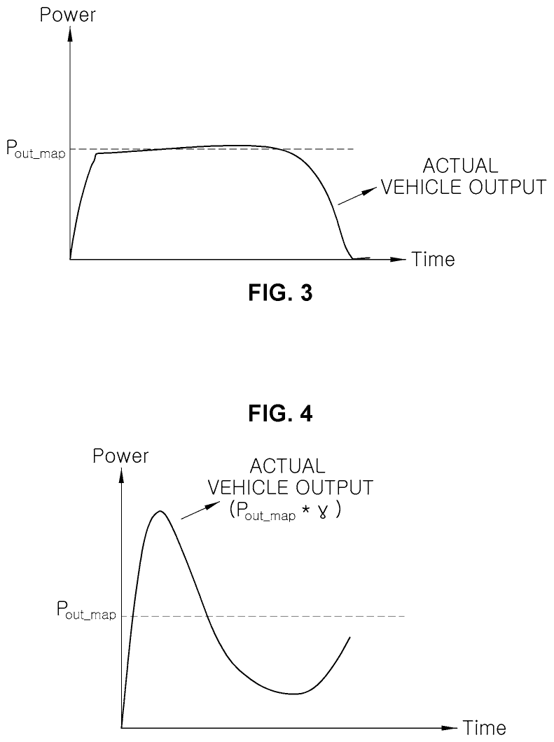

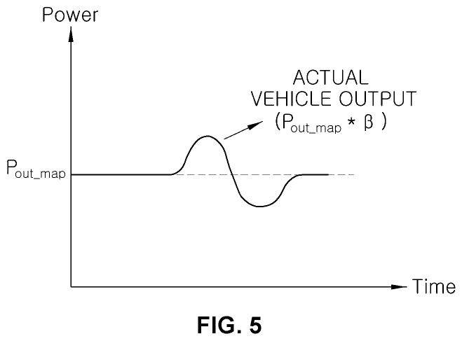

FIG. 3, FIG. 4, and FIG. 5 are graphs for comparison between conventional battery output power when a vehicle is propelled and battery output power when the vehicle is propelled using a vehicle power control system using big data according to various exemplary embodiments of the present invention.

As shown in FIG. 3, in a conventional vehicle power control scheme, battery output greater than the available power value P_{out_map} stored in data map is not achieved, and thus it is not possible to obtain output desired by a driver when the vehicle is accelerated or propelled.

However, as shown in FIG. 4, when the vehicle is requested to be propelled and accelerated, the vehicle power control system according to various exemplary embodiments of the present invention may obtain sufficient output desired by the driver when the vehicle is propelled by applying the high-output propulsion tolerance γ as a weight which is changed over time, which is set for each propulsion acceleration pattern of the driver.

As shown in FIG. 5, when the vehicle is requested to be overtaken and accelerated, the vehicle power control system according to various exemplary embodiments of the present invention may obtain sufficient output desired by the driver when the vehicle is overtaken by applying the high-output overtaking tolerance β as a weight which is changed over time, which is set for each overtaking acceleration pattern of the driver.

The vehicle power control system using big data may control power of the vehicle based on a vehicle acceleration pattern established based on big data without a limit in an available power value of a pre-stored data map, and thus may achieve acceleration and propulsion performance of the vehicle, desired by the driver.

Furthermore, the term “controller” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle power control system using big data, the system comprising:
a big-data server configured to receive driving-related data of a vehicle, generated by the vehicle, to generate a factor related to an acceleration pattern of the vehicle by processing the received driving-related data, and to store the generated factor; and
a controller installed in the vehicle and configured to, when the vehicle is requested to be accelerated or propelled, change output power of a battery with reference to pre-stored available power of the battery and the factor stored in the big-data server.

2. The vehicle power control system of claim 1, wherein the big-data server is configured to group acceleration patterns having similarity according to the factor, and to determine high-output tolerance corresponding to a corresponding acceleration pattern for each grouped group.

3. The vehicle power control system of claim 1, wherein the big-data server has a plurality of hierarchical structures, and includes:
a low-ranking layer cloud server which is lower than a predetermined layer cloud server, the low-ranking layer cloud server configured to directly receive the driving-related data of the vehicle from the vehicle and to classify data used to determine the factor, related to the acceleration pattern; and
a high-ranking layer cloud server which is higher than the predetermined layer, the high-ranking layer cloud server configured to generate the factor by receiving and processing the data classified by the low-ranking layer cloud server, and to group acceleration patterns having similarity according to the generated factor.

4. The vehicle power control system of claim 1, wherein the pre-stored available power of the battery is stored in the controller in a form of data map based on a state of charge (SOC) value of the battery and a temperature around the battery.

5. The vehicle power control system of claim 2, wherein the controller is configured to determine output power of the battery by applying the high-output tolerance to the pre-stored available power of the battery when the vehicle is in an acceleration or propulsion condition.

6. The vehicle power control system of claim 2, wherein the high-output tolerance is a weight varying over time, to which characteristics of the acceleration patterns belonging to each grouped group are applied.

7. A method of controlling a vehicle power control system using big data, the method comprising:
when a vehicle is powered on, receiving, by a big-data server, data related to driving of the vehicle in a preset time interval;
establishing, by the big-data server, an acceleration pattern of the vehicle by processing the data related to the driving of the vehicle received from a plurality of vehicles; and
grouping acceleration patterns according to a factor used to establish the acceleration pattern of the vehicle; and
changing, by a controller of the vehicle, output power of a battery in the vehicle with reference to pre-stored available power of the battery and the factor stored in the big-data server.

8. The method of claim 7,
wherein the acceleration patterns include a propulsion acceleration pattern and an overtaking acceleration pattern,
wherein the propulsion acceleration pattern is a pattern in which the vehicle is accelerated from a stationary state, and
wherein the overtaking acceleration pattern is a pattern in which, while traveling at a predetermined speed or greater, the vehicle is accelerated at a greater speed than the predetermined speed.

9. The method of claim 7, further including:
determining high-output tolerances corresponding to the acceleration patterns belonging to respective groups for each group which is grouped.

10. The method of claim 9,
wherein the high-output tolerances include a high-output propulsion tolerance and a high-output overtaking tolerance, and
wherein the high-output propulsion tolerance is applied to the propulsion acceleration pattern, and the high-output overtaking tolerance is applied to the overtaking acceleration pattern.

11. The method of claim 10, further including:
making, by the controller of the vehicle, a request to the big-data server for information on groups of the acceleration patterns and receiving, by the controller, the information.

12. The method of claim 11, further including:
when the vehicle is requested to be accelerated, determining, by the controller, whether the corresponding acceleration is propulsion acceleration or overtaking acceleration.

13. The method of claim 12, wherein when the corresponding acceleration is the propulsion acceleration, the controller is configured to determine a final battery output power by applying the high-output propulsion tolerance corresponding to a group of the propulsion acceleration pattern to an available power value of the battery.

14. The method of claim 12, wherein when the corresponding acceleration is the overtaking acceleration, the controller is configured to determine a final battery output power by applying the high-output overtaking tolerance corresponding to a group of the overtaking acceleration pattern to an available power value of the battery.

15. The method of claim 7, wherein the big-data server has a plurality of hierarchical structures, and includes:
a low-ranking layer cloud server which is lower than a predetermined layer cloud server, the low-ranking layer cloud server configured to directly receive the data related to the driving of the vehicle from the vehicle and to classify data used to determine the factor, related to the acceleration pattern; and
a high-ranking layer cloud server which is higher than the predetermined layer, the high-ranking layer cloud server configured to generate the factor by receiving and processing the data classified by the low-ranking layer cloud server, and to group the acceleration patterns having similarity according to the generated factor.

16. The method of claim 7, wherein the pre-stored available power of the battery is stored in the controller in a form of data map based on a state of charge (SOC) value of the battery and a temperature around the battery.

17. The method of claim 7, wherein the controller is configured to determine output power of the battery by applying a high-output tolerance to the pre-stored available power of the battery when the vehicle is in an acceleration or propulsion condition.

18. The method of claim 9, wherein the high-output tolerances are weights varying over time, to which characteristics of the acceleration patterns belonging to the respective groups are applied.
